(19) United States
(12) Patent Application Publication
(10) Pub. No.: US 2008/0279615 A1
(43) Pub. Date: Nov. 13, 2008

(54) Writing implement with replaceable tip

(76) Inventors: Lisa J. Tirone, Blairstown, NJ (US); Hope E. Sedeghat, Wayne, NJ (US)

Correspondence Address: Pearl Cohen Zedek Latzer, LLP, 1500 Broadway, 12th Floor, New York, NY, 10036, US

(21) Appl. No.: 11/797,809

(22) Filed: May 8, 2007

(51) Int. Cl. B43K 3/00; B43K 5/00

(52) U.S. Cl. 401/251; 401/88

(57) ABSTRACT

This invention relates to writing implement having replaceable tips and kits comprising the same.

### FIELD OF INVENTION

This invention is directed to a writing implement having replaceable writing tips.

### BACKGROUND OF THE INVENTION

Children all over the world use various writing implements to draw and color. Most products are inexpensive and fun initially. These writing implements are crayons, markers, colored pencils pens and the like.

The problem with Crayons is that once the tip is gone by either being broken or becoming dull, the user is left with a flat coloring implement. Likewise, once the tip breaks as the result of pressing down on the crayon at an angle, the user is left with two choices; first is to peel back the paper covering of the crayon, leaving a flat end that needs to be further sharpened; or second, discard the crayon altogether and obtaining a new one.

The first option is disadvantageous due to the shortened length of the crayon, which raise problems with dexterity and the ability to manipulate the crayon, while the second method is wasteful.

The present invention intends to address some of these issues.

### SUMMARY OF THE INVENTION

In one embodiment, the invention provides a writing implement comprising: an elongated member having a proximal end and a distal end; and a coupling means, capable of coupling a molded writing tip, wherein said coupling means is disposed at the distal end of said elongated member.

In another embodiment, the invention provides a writing kit, comprising a writing implement comprising: an elongated member having a proximal end and a distal end; and a coupling means, capable of coupling a molded writing tip, wherein said coupling means is disposed at the distal end of said elongated member; a plurality of molded tips; and packaging.

Other features and advantages of the present invention will become apparent from the following detailed description and figures. It should be understood, however, that the detailed description and the figures while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be better understood from a reading of the following detailed description taken in conjunction with the drawings in which like reference designators are used to designate like elements, and in which:

FIG. 1. shows A: the writing implement (10), having a molded tip (20), which comprises a coupling means (30) in the form of a cylinder, and a coupling means (21) extending from the base of the molded tip (20), capable of coupling the replaceable tip (20) to the elongated member (10). B. shows the elongated member (10), with coupling means (30) recessed into the elongated member, thereby defining a wall extending above the base of the coupling means (30) which is a screw (31) extending beyond the proximal end of the elongated member (10). C. shows a baffle (11) disposed inside the recess proximal end of the elongated member (10), preventing rotational movement with the coupling means (30) operably linked to the rotating base (12), which is operably linked to the distal end of the elongated member (10). D. shows with the coupling means (30) operably linked to the rotating base (12), which is operably linked to the distal end of the elongated member (10). E. shows the coupling means, an internally treaded cylinder (30) operably linked to the rotating base (12), which is operably linked to the distal end of the elongated member (10), capable of coupling the molded tip (20) having a coupling means (21) attached at the base of the molded tip (20).

### DETAILED DESCRIPTION OF THE INVENTION

This invention relates in one embodiment to writing implements having replaceable tips, and in another embodiment, to writing kits comprising the same

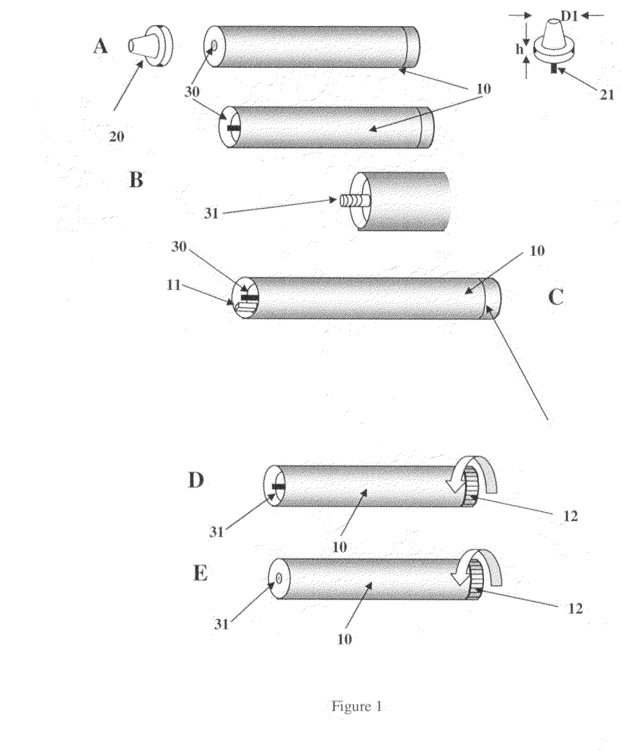

In one embodiment provided herein is a writing system comprising replaceable tips capable of being functionally attached to a carrier writing implement, Attention now is turned to FIG. 1A, showing the writing implement (10). In one embodiment, the writing implement (10) is comprised of a resilient material, such as resin, wood, metal, and the like. The elongated member (10) is substantially cylindrical in one embodiment, or of other shapes in other embodiments, such as a front profile cross cut polygons having 3-8 sides in other embodiments. In one embodiment, the elongated member (10) is substantially cylindrical and is between about 2 to about 12 inches in length (˜5 to ˜31 cm), and between about 0.125 to about 0.75 inches in diameter. In another embodiment, when cross cut profile of the elongated member is a polygon having between 3 and 8 sides, dimensions are between about 2 to about 12 inches in length (˜5 to ˜31 cm), and between about 0.125 to about 0.75 inches in width.

In one embodiment, the molded tip used in the writing implement described herein, is a crayon, having a frusto-conical tip, or a conical tip, attached to a base having a cross cut profile that matches the elongated member (10), cross cut profile to which it is coupled in one embodiment, or is substantially cylindrical in one embodiment, or of other shapes in other embodiments, such as a front profile cross cut polygons having 3-8 sides. In one embodiment, the base dimensions of D1 between about 0.125 to about 0.75 inches and of “h” as shown in FIG. 1A, of between about 0.125 to about 0.5 inch.

The molded tips used for writing or coloring implements described herein, comprise a material that is solid or waxy at room temperatures but which evenly abrade or soften sufficiently upon the application of sliding abrasive force against one surface of the material. The molded tips (20) are provided in one embodiment, as stick-like or cylindrical elements of the waxy material, with a protective wrapping around it in another embodiment. The waxy material may be either clear (to provide a shiny, colorless background) or pigmented to provide a color. In one embodiment the material contains a sufficiently large amount of pigment so that a reflective optical density of about 1 would be obtained with a 0.3 mm thick coating of the molded tip's material.

The waxy material may be a natural wax in one embodiment, or synthetic wax, microcrystalline wax or any other type of material that exhibits conventional wax properties in other embodiments. That is, the material should be able to retain its general shape at room temperature (about 18-25° C.) for at least eight hours, the capacity to acquire gloss when rubbed, and the like. Common waxes used in the formation of formation of the molded tips described herein and other writing implements include in another embodiment esters of high molecular weight fatty acids with high molecular weight alcohols or fatty alcohols, or mixtures of esters with fatty acids and alcohols and hydrocarbons, or esters of fatty acids with high atomic weight alcohol radicals, either natural or synthetic, such as beeswax, or myricyl palmitate, carnauba wax, or synthetic polymers, particularly amorphous or microcrystalline polymers such as polypropylene, polyethylene, terpen resins, phenolic resins and the like. The use of many of these materials in the formation of crayons is described in U.S. Pat. Nos. 3,491,043 and 3,933,708 are incorporated herein by reference in their entirety and may be used to mold the replaceable tips provided herein. In one embodiment, the molded tips include dyes and/or pigments in the waxy composition to provide the desired colors to them.

In one embodiment the coupling means (30) in FIG. 1A-E are intended to include all means that will be able to couple the molded tip onto the elongated member of the writing implement. These are in one embodiment, a pin that may be blunt ended or sharpened, or a screw having a tread that is adaptable to engage the molded tip by treading into the tip in another embodiment, or an internally treaded cylinder adapted to engage a screw extending from the base (21) of the molded tip (20).

In another embodiment, the elongated member has a rotating base (12) operably linked to the distal end of the elongated member (10), which is attached to the coupling means (30). In one embodiment, rotating the base (12) of the elongated member (10), rotates the coupling means (30), engaging the molded tip (20) thereby coupling the molded tip (20) onto the proximal end of the elongated member (10). In one embodiment, the coupling means are recessed into the elongated member, creating a cylinder extending above the tip of the coupling means. In one embodiment, the recessed portion in the proximal end of the elongated member (10), is between about 0.125 to 0.5 inch in depth, thereby reducing in one embodiment, the risk of injury from the coupling means (30) of the elongated member (10). In another embodiment, the elongated member (10), having a recessed coupling means (30), further comprise a baffle (11), disposed within the recess, preventing rotational motion of the molded tip, which in another embodiment, comprise a slit adapted to ft around the baffle (11).

Colors, of course, may vary over a wide range. Likewise, the uses may vary over a wide range and need not be limited to crayons for children. They could include, for example, oil based pastels used for artist drawings, markers for erasable boards, etc. The colors can vary from all the primary colors to colors such as lemon yellow, yellow, yellow okra, pail orange, orange, brown, red, pink, pale blue, cobalt blue, ultra marine, green, yellow green, black, gray, white, etc., all without limitation.

The term “about” as used herein means in quantitative terms plus or minus 5%, or in another embodiment plus or minus 10%, or in another embodiment plus or minus 15%, or in another embodiment plus or minus 20%.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

What is claimed is:

1. A writing implement comprising:
a. an elongated member having a proximal end and a distal end; and
b. a coupling means, capable of coupling a molded writing tip, wherein said coupling means is disposed at the distal end of said elongated member and comprise a pin, a screw, an interrupted tread screw, an internally treaded cylinder or an internally interrupted tread cylinder.

2. The implement of claim 1, wherein the molded tip is a crayon tip, a pencil tip, a pen tip, or a marker tip.

3. The implement of claim 1, wherein the coupling means is recessed into the elongated member, and wherein the writing tip is adapted to fit into the recess.

4. The implement of claim 1, wherein said coupling means substantially inhibit rotational movement of the molded tip radially to the coupling means.

5. The implement of claim 1, further comprising a rotating base operably linked to the distal end of the elongated member and to the coupling means.

6. The implement of claim 5, wherein the molded writing tip comprises a screw extending from a base of the writing tip.

7. A writing kit, comprising the writing implement of any one of claims 1-6; a plurality of molded tips; and packaging.

8. The kit of claim 7, further comprising more than a single writing implement.

9. The kit of claim 7, wherein the molded tip is a crayon tip, a pencil tip, a pen tip, or a marker tip.

10. The kit of claim 7, wherein the coupling means is recessed into the elongated member, and wherein the writing tip is adapted to fit into the recess.

11. The kit of claim 7, wherein said coupling means is a pin, a screw, or a screw having interrupted tread.

12. The kit of claim 7, wherein said coupling means substantially inhibit rotational movement of the molded tip radially to the coupling means.

13. The kit of claim 7, wherein the molded tips are in a plurality of colors.
